(19) United States
(12) Patent Application Publication
(10) Pub. No.: US 2024/0284934 A1
(43) Pub. Date: Aug. 29, 2024

(54) METHOD FOR MANUFACTURING PLANT-BASED MEAT WITH ARTIFICAL MUSCLE FIBER INSERTED

(71) Applicant: BIPPECO, Seoul (KR)

(72) Inventors: Hyun Jin PARK, Seoul (KR); Hyun Jung KO, Siheung-si (KR)

(73) Assignee: BIPPECO, Seoul (KR)

(21) Appl. No.: 18/573,936

(22) PCT Filed: Aug. 26, 2021
(86) PCT No.: PCT/KR2021/011460

§ 371 Date: Dec. 22, 2023

(30) Foreign Application Priority Data
Jun. 24, 2021 (KR) 10-2021-0082096

(51) Int. Cl. A23J 3/22; A23J 3/14; A23L 33/105; A23P 20/25

(52) U.S. Cl. CPC A23J 3/227; A23J 3/14; A23L 33/105; A23P 20/25; A23P 2020/253

(57) ABSTRACT

The present invention relates to a method for manufacturing plant-based meat with artificial muscle fiber inserted therein. The method for manufacturing plant-based meat with artificial muscle fiber inserted therein, according to an embodiment of the present invention, comprises: a step of preparing an artificial muscle fiber composition by mixing alginic acid, carrageenan, and glucomannan in distilled water (S100); and a step of injecting the artificial muscle fiber composition into an inner nozzle of a 3D printer having double nozzles in which the inner nozzle is inserted inside an outer nozzle, injecting a vegetable protein composition into the outer nozzle, and then conducting 3D printing (S200).

### TECHNICAL FIELD

The present invention relates to a method for producing a meat analogue through artificial muscle fiber insertion, and more specifically to a method for producing a meat analogue with similar physical properties to the texture of actual meat by inserting a mixture of curable hydrocolloids into a plant-based protein matrix.

### BACKGROUND ART

It is anticipated that livestock breeding alone will not be enough to meet future demand for meat due to the limitation of resources such as land and water and environmental problems such as greenhouse gas emissions. Further, as the number of vegetarians who consume plant foods for health increases, meat analogues such as plant-sourced meat are being developed. With the recognition that plant-sourced meat analogues made from proteins extracted from vegetables and soybeans relieve concerns about intake of saturated fats and antibiotics through animal-sourced meat, relevant research and product development are being actively underway.

In recent years, radiation, extrusion, and steam methods have been studied for the texture of plant-sourced meat analogues. Among them, the extrusion method is the most representative one. According to the extrusion method, plant-based proteins are extracted, mixed with water, and extruded in an extruder under heat and high pressure to form a texture that is made plastic and elastic by various actions such as pressure, heat, and mechanical shear force. Due to their texture similar to actual meat, ground products of the extrudate are mainly used to imitate processed meat products, for example, ground meat products such as hamburger patties and sausages.

However, conventional methods for the texture of plant-based meat analogues fail to achieve satisfactory sensory quality levels of meat analogues in terms of taste and texture over actual meat and to imitate inherent characteristics such as texture and marbling that come from the muscle fibers and adipose tissue of actual meat, limiting the consumption pattern of meat analogues to ground meat products.

Thus, there is an urgent need to develop a next-generation method for producing a textured meat analogue in which the inherent muscle fiber tissue of meat is realized.

### DETAILED DESCRIPTION OF THE INVENTION

### Problems to be Solved by the Invention

The present invention has been made in an effort to solve the problems of the prior art, and an aspect of the present invention is to provide a method for producing a meat analogue, in which an artificial muscle fiber material is inserted, using a 3D printer equipped with a coaxial nozzle.

### Means for Solving the Problems

A method for producing a meat analogue through artificial muscle fiber insertion according to an embodiment of the present invention includes (a) mixing alginic acid, carrageenan, and glucomannan in distilled water to prepare an artificial muscle fiber composition and (b) feeding the artificial muscle fiber composition into an inner nozzle of a dual-nozzle 3D printer in which the inner nozzle is insertedly arranged inside an outer nozzle, feeding a plant-based protein composition into the outer nozzle, followed by 3D printing.

According to an exemplary embodiment of the present invention, the artificial muscle fiber composition may include, based on its total weight, 0.5 to 3.0% by weight of the alginic acid, 0.5 to 5.0% by weight of the carrageenan, 0.5 to 3.0% by weight of the glucomannan, and the balance distilled water.

According to an exemplary embodiment of the present invention, the artificial muscle fiber composition may include the alginic acid, the carrageenan, and the glucomannan in a weight ratio of 1:2-3:1-2.

According to an exemplary embodiment of the present invention, the outer nozzle may have a diameter of 1.4 to 1.6 nm and the inner nozzle may have a diameter of 0.8 to 1.2 nm.

According to an exemplary embodiment of the present invention, the artificial muscle fiber composition may be ejected at a speed of 0.02 to 0.04 ml/min.

According to an exemplary embodiment of the present invention, the method may further include (c) heating the 3D printed product.

According to an exemplary embodiment of the present invention, in step (c), the 3D printed product may be heated at 150 to 200° C. for 20 to 30 minutes.

According to an exemplary embodiment of the present invention, the method may further include (d) cooling the heated printed product.

According to an exemplary embodiment of the present invention, in step (d), the heated printed product may be cooled at 20 to 30° C. for 10 to 20 minutes.

The features and advantages of the present invention will become apparent from the following description with reference to the accompanying drawings.

Prior to the detailed description of the invention, it should be understood that the terms and words used in the specification and the claims are not to be construed as having common and dictionary meanings but are construed as having meanings and concepts corresponding to the technical spirit of the present invention in view of the principle that the inventor can define properly the concept of the terms and words in order to describe his/her invention with the best method.

### Effects of the Invention

The method of the present invention enables the production of a meat analogue in which muscle fibers and adipose tissue similar to those of actual meat are realized. Therefore, the method of the present invention can extend the range and consumption pattern of available products.

In addition, the use of 3D printing technology in the method of the present invention enables free design and control of the texture of a meat analogue. Therefore, the method of the present invention can provide a meat analogue that imitates the characteristics of various types of meat.

### BRIEF DESCRIPTION OF THE DRAWINGS

FIG. 1 is a flowchart illustrating a method for producing a meat analogue through artificial muscle fiber insertion according to an embodiment of the present invention.

FIG. 2 is a view for explaining the 3D printing step of FIG. 1.

FIG. 3 is a flowchart illustrating a method for producing a meat analogue through artificial muscle fiber insertion according to a further embodiment of the present invention.

FIG. 4 shows changes in the dynamic viscoelastic properties (storage modulus (A, G′) and loss modulus (B, G″)) of artificial muscle fiber compositions prepared in Experimental Example 1.

FIG. 5 shows the activation effects of Ca²⁺ and K⁺ ions on the rheological properties of artificial muscle fiber compositions prepared in Experimental Example 1.

FIG. 6 shows changes in the dynamic viscoelastic properties (storage modulus (G′)) of artificial muscle fiber compositions prepared in Experimental Example 1 during heating and cooling.

FIG. 7 shows images revealing a 3D printing process for artificial muscle fiber insertion using a coaxial nozzle in Experimental Example 2 and the microstructures of a printed meat analogue and inserted artificial muscle fibers.

FIG. 8 shows images confirming whether meat analogues in which artificial muscle fibers were inserted formed textures after cooking in Experimental Example 3.

FIG. 9 compares the mechanical strengths of meat analogues, in which artificial muscle fibers were inserted, and beef.

### BEST MODE FOR CARRYING OUT THE INVENTION

The objects, specific advantages, and novel features of the present invention will become apparent from the following detailed description and preferred embodiments in conjunction with the accompanying drawings. It should be noted that in the drawings, the same components are denoted by the same reference numerals even though they are depicted in different drawings. In the description of the present invention, detailed explanations of related art are omitted when it is deemed that they may unnecessarily obscure the essence of the present invention.

Preferred embodiments of the present invention will now be described in detail with reference to the accompanying drawings.

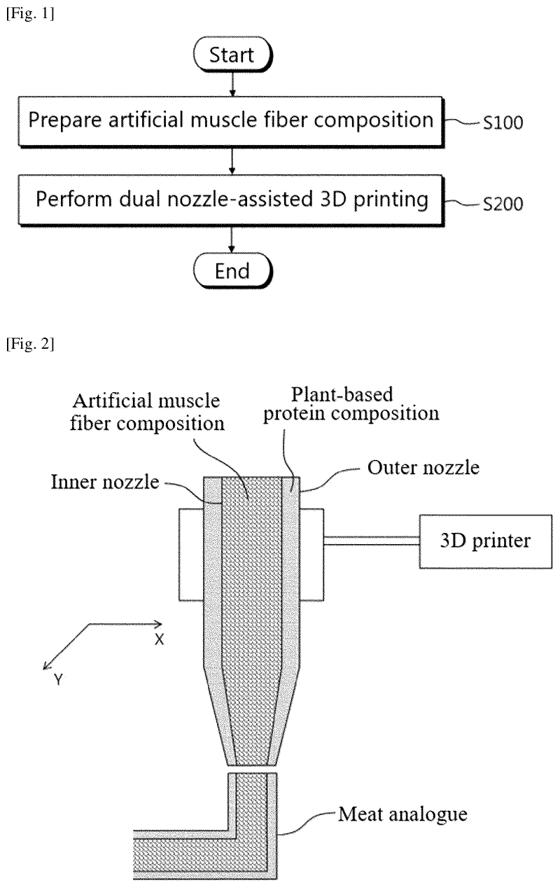

FIG. 1 is a flowchart illustrating a method for producing a meat analogue through artificial muscle fiber insertion according to an embodiment of the present invention and FIG. 2 is a view for explaining the 3D printing step of FIG. 1.

As shown in FIGS. 1 and 2, the method includes (S100) mixing alginic acid, carrageenan, and glucomannan in distilled water to prepare an artificial muscle fiber composition and (S200) feeding the artificial muscle fiber composition into an inner nozzle of a dual-nozzle 3D printer in which the inner nozzle is insertedly arranged inside an outer nozzle, feeding a plant-based protein composition into the outer nozzle, followed by 3D printing.

The present invention is directed to a method for producing a meat analogue with similar physical properties to the texture of actual meat. Radiation, extrusion, and steam methods have been studied for the texture of plant-sourced meat analogues. However, these conventional methods fail to achieve satisfactory sensory quality levels of meat analogues in terms of taste and texture over actual meat and to imitate inherent characteristics such as texture and marbling that come from the muscle fibers and adipose tissue of actual meat, limiting the consumption pattern of meat analogues to ground meat products. Thus, the present invention has been devised to provide a next-generation method for producing a textured meat analogue in which the inherent muscle fiber tissue of meat is realized.

As described above, the method includes (S100) preparing an artificial muscle fiber composition and (S200) 3D printing.

In S100, an artificial muscle fiber material is prepared. The artificial muscle fiber material is inserted in a final meat analogue. The artificial muscle fiber material realizes a muscle fiber tissue structure similar to that of actual meat to imitate the inherent characteristics (such as texture and marbling) of actual meat and improves the sensory quality levels in terms of taste and texture.

The artificial muscle fiber composition uses hydrocolloids because it should be incorporated into a plant-based protein material to realize a sense of texture through mechanisms such as temperature change and ionic bonding in the subsequent step. Hydrocolloids are hydrophilic polymers that exhibit viscosity or are gelled when hydrated in water. Hydrocolloids exhibit various characteristics depending on factors such as polymer composition, molecular weight, functional group, and concentration.

Specifically, the artificial muscle fiber composition is prepared by mixing alginic acid, carrageenan, and glucomannan in distilled water. Alginic acid exhibits acidic properties and is non-toxic and easy to process. Alginic acid becomes highly viscous when dissolved in water. Carrageenan is a natural polysaccharide extracted from various species of red algae and can be used as a thickener, stabilizer, emulsifier, etc. in the cosmetic and food fields. Alginic acid and carrageenan can react with cations to form a hydrogel whose stiffness depends on the type and concentration of ions present therein. Glucomannan has synergistic effects with other gums, exhibits flowability, and acts as a dietary fiber for intestinal regulation. Particularly, glucomannan can greatly affect the physical properties of foods due to its stickiness when used as a gelling agent.

The artificial muscle fiber composition is a mixture of alginic acid, carrageenan, glucomannan, and distilled water and may include, based on its total weight, 0.5 to 3.0% by weight of the alginic acid, 0.5 to 5.0% by weight of the carrageenan, 0.5 to 3.0% by weight of the glucomannan, and the balance distilled water. The artificial muscle fiber composition may also include the alginic acid, the carrageenan, and the glucomannan in a weight ratio of 1:2-3:1-2. The types of the components of the artificial muscle fiber composition and their mixing ratio are very important factors in preparing a meat analogue with a similar muscle fiber tissue structure to that of actual meat. Further details can be found in experimental examples that follow.

In S200, a dual-nozzle 3D printer is used to print a meat analogue. The dual nozzle is a coaxial nozzle composed of an outer nozzle and an inner nozzle insertedly arranged inside the outer nozzle. The dual nozzle ejects materials fed thereinto while moving right, left, up, and down. Any known 3D printer that can print food materials may be used without particular limitation, and thus a detailed description thereof is omitted.

The artificial muscle fiber composition is fed into the inner nozzle and a plant-based protein composition is fed into the outer nozzle. The plant-based protein composition is not particularly limited as long as it includes proteins extracted from plants such as soybean and wheat and can be used to produce a plant-sourced meat analogue. For example, the plant-based protein composition may include a soybean protein and gluten, a wheat protein.

The dual nozzle-assisted 3D printing is performed to insert the artificial muscle fiber composition ejected from the inner nozzle into the plant-based protein composition ejected from the outer nozzle. The outer nozzle may have a diameter of 1.4 to 1.6 nm and the inner nozzle may have a diameter of 0.8 to 1.2 nm. The artificial muscle fiber composition may be ejected at a speed of 0.02 to 0.04 ml/min.

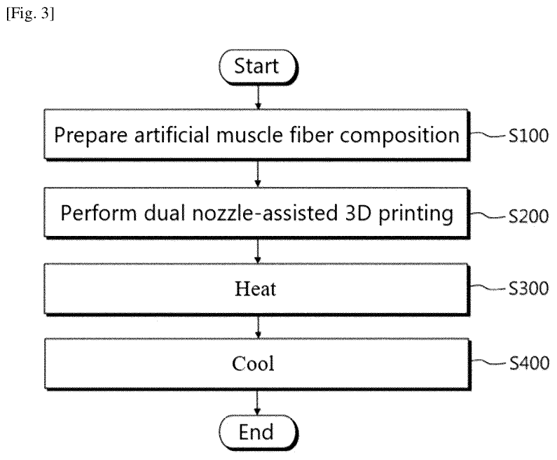

FIG. 3 is a flowchart illustrating a method for producing a meat analogue through artificial muscle fiber insertion according to a further embodiment of the present invention.

Referring to FIG. 3, the method may include (S300) heating the 3D printed product.

In S300, the 3D printed product as a meat analogue is heated. The meat analogue may be heated at 150 to 200° C. for 20 to 30 minutes.

The method may further include (S400) cooling the heated printed product. In S400, the heated meat analogue may be cooled at 20 to 30° C. for 10 to 20 minutes.

Overall, the method of the present invention enables the production of a meat analogue in which muscle fibers and adipose tissue similar to those of actual meat are realized. Therefore, the method of the present invention can extend the range and consumption pattern of available products. In addition, the use of 3D printing technology in the method of the present invention enables free design and control of the texture of a meat analogue. Therefore, the method of the present invention can provide a meat analogue that imitates the characteristics of various types of meat.

### MODE FOR CARRYING OUT THE INVENTION

The present invention will be described in more detail with reference to the following experimental examples. In these experimental examples, meat analogues were produced through artificial muscle fiber insertion and their similarity to actual meat was verified. To this end, the effects of the mixing ratio of hydrocolloids on rheological properties, suitability for 3D printing, applicability to coaxial nozzle, cooking characteristics, and textural strength were analyzed.

### EXPERIMENTAL EXAMPLE 1: PREPARATION AND EVALUATION OF RHEOLOGICAL PROPERTIES OF ARTIFICIAL MUSCLE FIBER COMPOSITIONS

Alginic acid, carrageenan, glucomannan, and distilled water were mixed in the amounts shown in Table 1 to prepare artificial muscle fiber compositions for the production of meat analogues that mimic meat.

TABLE 1

| | Materials and their mixing ratios | | | |
|---|---|---|---|---|
| | Alginic | | | Distilled |
| | acid | Carrageenan | Glucomannan | water |
| Composition 1 | 1.0 | 1.5 | 0 | 97.5 |
| Composition 2 | 1.0 | 2.5 | 0 | 96.5 |
| Composition 3 | 1.0 | 1.5 | 1.5 | 96 |
| Composition 4 | 1.0 | 2.5 | 1.5 | 95 |

Compositions 1 and 2 contain alginic acid, carrageenan, and distilled water in weight ratios of 1:1.5:97.5 and 1:2.5:96.5, respectively. Compositions 3 and 4 contain alginic acid, carrageenan, glucomannan, and distilled water in weight ratios of 1:1.5:1.5:96 and 1:2.5:1.5:95, respectively.

Alginic acid, carrageenan, and glucomannan were mixed in a powder state based on the mixing ratios shown in Table 1. Each of the mixtures was dispersed in 5 wt % of distilled water. Subsequently, the aqueous solution was hydrated in a refrigerator at 4° C. for 24 h before use in experiments.

The rheological analysis of artificial muscle fibers was performed through three types of experiments tests: frequency sweep, curing, and temperature sweep tests. The three-step rheological verification allowed the monitoring of the rheological behavior before and during processing and after cooking.

The frequency sweep test evaluates the flowability when the artificial muscle fibers are extruded from the reservoir before revolution. This was measured using a controlled stress rheometer (Paar Physica MCR 302, Anton Paar, Graz, Austria), whose gap was set to 1 mm, with a sandblasted parallel plate (PP25/S) having a diameter of 25 mm. A strain sweep test was conducted at 10 rad/s to obtain the linear viscoelastic (LVE) region between shear stress and shear strain for dynamic viscoelastic analysis. A strain of 0.1% within the linear viscoelastic region was selected as an experimental condition. All samples were left standing for 15 min after being loaded into the rheometer to allow for the recovery of collapsed internal structures. Thereafter, the storage (G′) and loss moduli (G″) were measured with an analysis program (RheoCompass™, Anton Paar, Graz, Austria) embedded in the rheometer.

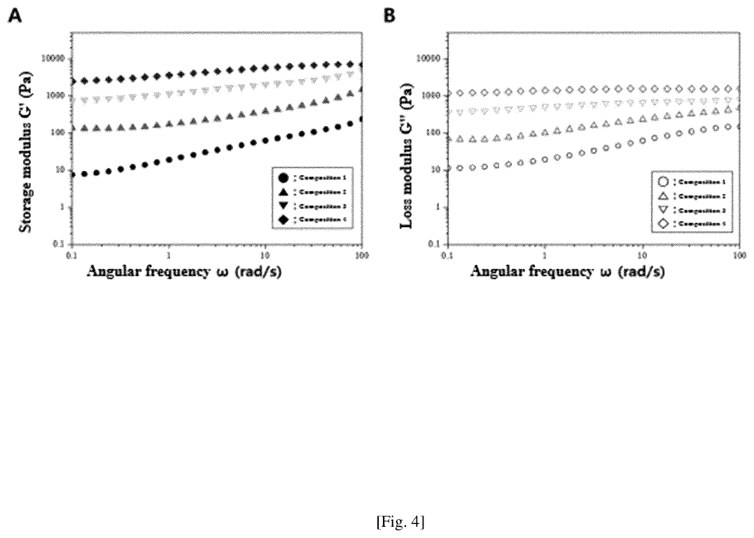

FIG. 4 shows changes in the dynamic viscoelastic properties (storage modulus (A, G′) and loss modulus (B, G″)) of the artificial muscle fiber compositions prepared in Experimental Example 1. Referring to FIG. 4, the G′ and G″ values of the compositions increased proportionally to the total amounts of the dispersed hydrocolloids. These results indicate that the rheological properties of the artificial muscle fiber compositions depend entirely on the total amounts of the hydrocolloids incorporated before feeding of a plant-based protein composition in the subsequent step for meat analogue production.

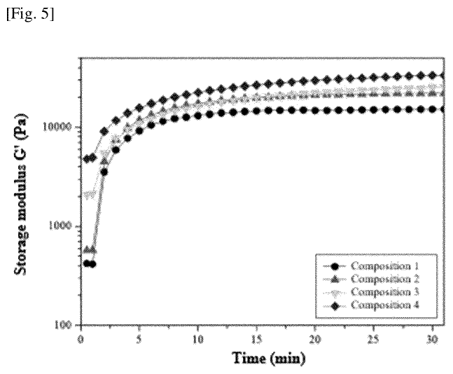

FIG. 5 shows the activation effects of Ca²⁺ and K⁺ ions on the rheological properties of the artificial muscle fiber compositions prepared in Experimental Example 1. Referring to FIG. 5, the G′ values of all the compositions after curing increased proportionally to the total amounts of the incorporated hydrocolloids, which is consistent with the trend shown in FIG. 4. As can be seen from the results in FIG. 5, the artificial muscle fiber compositions inserted in the meat analogues combined with Ca²⁺ and K⁺ ions present in the meat analogues to form elastic meat textures and fibrous structures, which proceeded very fast.

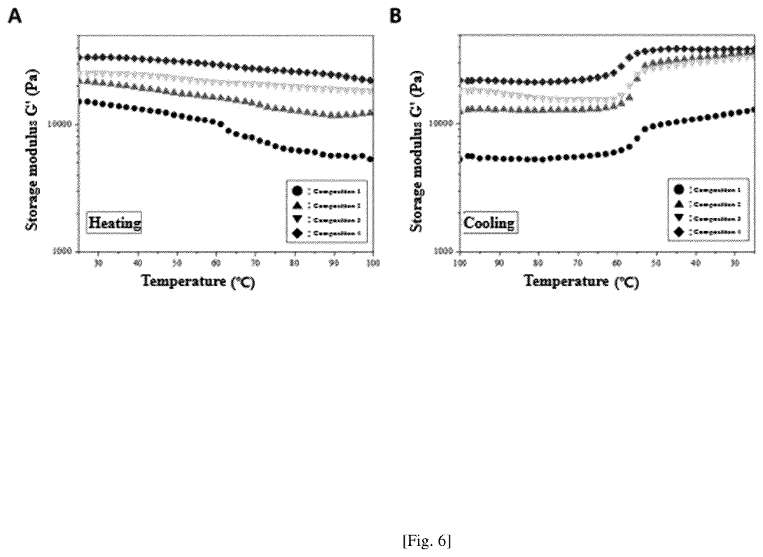

FIG. 6 shows changes in the dynamic viscoelastic properties (storage modulus (G′)) of the artificial muscle fiber compositions prepared in Experimental Example 1 during heating and cooling. Referring to FIG. 6, the G′ values of the artificial muscle fiber compositions showed a tendency to decrease with increasing temperature. Noticeable decreases in the physical properties of Compositions 1 and 2 without glucomannan were observed. As shown in B of FIG. 6, the G′ values of the artificial muscle fiber compositions were maintained while cooling from 100° C. to ˜60° C. and rapidly increased below 60° C. This is presumed to be due to the temperature of the incorporated carrageenan, leading to gel structure formation. The observation of high gel strengths in Compositions 2 and 4 with high carrageenan content demonstrates that this presumption is reasonable. These results suggest that meat analogues containing the artificial muscle fiber compositions with high carrageenan content can form more stable fiber textures after cooking.

### EXPERIMENTAL EXAMPLE 2: EVALUATION OF 3D PRINTING SUITABILITY AND COAXIAL NOZZLE APPLICABILITY OF THE ARTIFICIAL MUSCLE FIBER COMPOSITIONS

Soybean meat dough was fed into an outer nozzle with a diameter of 1.6 mm and each of the artificial muscle fiber compositions prepared in Experimental Example 1 was fed into an inner nozzle with a diameter of 1 mm. Thereafter, the materials were subjected to 3D printing while being ejected. As a result, a meat analogue was printed in which the artificial muscle fiber composition was inserted into the soybean meat dough. The artificial muscle fiber composition was ejected at a speed of 0.03 mL/min through a syringe pump (KDS-410, KD Scientific Inc., USA).

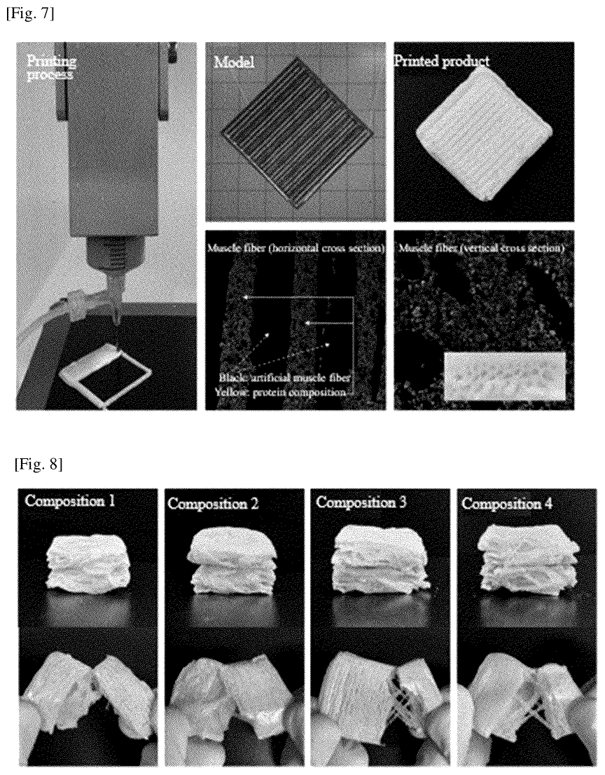

FIG. 7 shows images revealing the 3D printing process for artificial muscle fiber insertion using a coaxial nozzle in Experimental Example 2 and the microstructures of the printed meat analogue and the inserted artificial muscle fibers. As shown in FIG. 7, the artificial muscle fiber composition was gently extruded through the coaxial nozzle and showed no significant difference in appearance.

Referring to FIG. 7, a separation membrane was formed by rapid ionic bonding of the surface of the artificial muscle fibers adjacent to the cations present in the protein composition, revealing the artificial muscle fiber composition inserted into the protein composition forms an independent area without being mixed with the protein composition. Based on the results in FIG. 7, it can be confirmed that coaxial nozzle-assisted 3D printing is an effective production process for designing a muscle fiber mimic structure inside meat analogues.

### EXPERIMENTAL EXAMPLE 3: EVALUATION OF COOKING CHARACTERISTICS AND TEXTURAL STRENGTH OF THE ARTIFICIAL MUSCLE FIBER-INSERTED MEAT ANALOGUES

Each of the artificial muscle fiber-inserted meat analogues prepared in Experimental Example 2 was post-processed (heated) at 170° C. for 25 min. Then, the processed sample was cooled to 25° C. within 15 min. Beef (sirloin) was used as a control for measuring the textural properties of the meat analogues.

FIG. 8 shows images confirming whether the meat analogues in which artificial muscle fibers were inserted formed textures after cooking under heat in Experimental Example 3. As can be seen in FIG. 8, for Compositions 1 and 2 without glucomannan, the fibrous structures were cut when the textures of the meat analogues were broken due to their low textural strength. In contrast, the glucomannan-containing compositions were found to form muscle fiber-specific textures similar to actual meat due to their firm fiber structures.

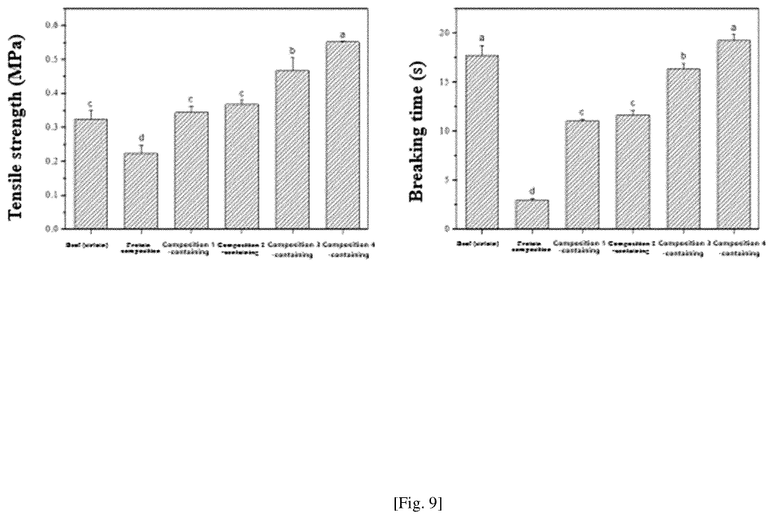

FIG. 9 compares the mechanical strengths of the meat analogues, in which artificial muscle fibers were inserted, and beef. The tensile strength was analyzed by measuring the force after a sample having dimensions of 1.5×5×0.7 cm was printed on a texture analyzer (TA.XT Plus, Texture Technologies, USA), attached to a rig, and stretched 30 mm at a speed of 1.0 mm/s in the direction in which artificial muscle fibers were inserted. The breaking time was measured with a texture analyzer (TA.XT Plus, Texture Technologies, USA) under the same conditions as for the tensile strength analysis. The breaking time was calculated based on the value of the unchanged point for 300 points. The tensile strength is the maximum load that a material can withstand when pulled to cut it, divided by the cross-sectional area of the material. Thus, it is a measurement of the maximum force applied when pulling the fiber. As a result, the meat analogue in which Composition 1 or 2 was inserted showed a tensile strength value similar to that of actual beef. However, all samples, including beef, were not completely disconnected after reaching the maximum load, and the breaking time was additionally observed to reflect the inherent elasticity of meat analogues. As shown in FIG. 9, as a result of measuring the time taken by the fiber bundles of the sample to be completely disconnected, the meat analogue containing Composition 4 showed fracture characteristics similar to those of beef. These results may serve as suitable indicators for selecting a formulation with similar strength and texture to the control group when compared with the texture of other meats, including beef.

Although the present invention has been described herein with reference to the foregoing specific embodiments, these embodiments do not serve to limit the invention and are set forth for illustrative purposes. It will be apparent to those skilled in the art that modifications and improvements can be made without departing from the spirit and scope of the invention.

Simple modifications and changes of the present invention belong to the scope of the present invention and the specific scope of the present invention will be clearly defined by the appended claims.

### INDUSTRIAL APPLICABILITY

The method of the present invention uses a coaxial nozzle-assisted 3D printer for artificial muscle fiber insertion, enabling the production of a meat analogue in which muscle fibers and adipose tissue similar to those of actual meat are realized. Therefore, the present invention is considered industrially applicable.

1. A method for producing a meat analogue through artificial muscle fiber insertion, comprising (a) mixing alginic acid, carrageenan, and glucomannan in distilled water to prepare an artificial muscle fiber composition and (b) feeding the artificial muscle fiber composition into an inner nozzle of a dual-nozzle 3D printer in which the inner nozzle is insertedly arranged inside an outer nozzle, feeding a plant-based protein composition into the outer nozzle, followed by 3D printing.

2. The method according to claim 1, wherein the artificial muscle fiber composition comprises, based on its total weight, 0.5 to 3.0% by weight of the alginic acid, 0.5 to 5.0% by weight of the carrageenan, 0.5 to 3.0% by weight of the glucomannan, and the balance distilled water.

3. The method according to claim 1, wherein the artificial muscle fiber composition comprises the alginic acid, the carrageenan, and the glucomannan in a weight ratio of 1:2-3:1-2.

4. The method according to claim 1, wherein the outer nozzle has a diameter of 1.4 to 1.6 nm and the inner nozzle has a diameter of 0.8 to 1.2 nm.

5. The method according to claim 1, wherein the artificial muscle fiber composition is ejected at a speed of 0.02 to 0.04 ml/min.

6. The method according to claim 1, further comprising (c) heating the 3D printed product.

7. The method according to claim 6, wherein, in step (c), the 3D printed product is heated at 150 to 200° C. for 20 to 30 minutes.

8. The method according to claim 6, further comprising (d) cooling the heated printed product.

9. The method according to claim 8, wherein, in step (d), the heated printed product is cooled at 20 to 30° C. for 10 to 20 minutes.
